(19) United States
(12) Patent Application Publication
(10) Pub. No.: US 2002/0092842 A1
(43) Pub. Date: Jul. 18, 2002

(54) Thermally efficient portable convective oven

(76) Inventor: Jerry Loveless, Tacoma, WA (US)

Correspondence Address: JERRY LOVELESS, 5334 BROWNS PT. BLVD. NE, TACOMA, WA, 98422, US

(21) Appl. No.: 10/092,451

(22) Filed: Mar. 7, 2002

Related U.S. Application Data
(63) Continuation-in-part of application No. 09/723,055, filed on Nov. 27, 2000, now Pat. No. 6,307,185.

(51) Int. Cl. A21B 1/22; A21B 1/14; A21B 1/26

(52) U.S. Cl. 219/400; 219/411; 219/399; 219/413

(57) ABSTRACT

A thermally efficient, low voltage, portable convection/conduction cooking oven that is an improvement of combination conduction/convection/radiant ovens, portable or permanently affixed in place. The oven contains a low thermal mass conductive cooking slab 6 heated by lower elements 17. The oven utilizes convective cooking by moving air with fan 10 across infrared bulbs 9A. The oven successfully utilizes 110-volt service, infrared bulb(s) 9A and lower elements 17 with a cumulative draw of no more than 1550 watts and 13.5 steady state amps while cooking foods in one fourth to one third the time of conventional ovens. The low thermal mass conductive cooking slab temperature is maintained optimally stable by means of lower heating elements 17 remaining energized throughout the conductive cooking process. The oven utilizes a unique grouping of thermally efficient improvements. These improvements produce in synergy a low profile, lightweight oven with exceptional preheating times, cooking times and end product food quality.

### CROSS-REFERENCE TO RELATED APPLICATION

This is a continuation-in part of application Ser. No. 09/723,055, Filed Nov. 27, 2000 now U.S. Pat. No. 6,307,185, granted Oct. 23, 2001.

### FIELD OF INVENTION

This invention relates to portable pizza type ovens, more particularly as an improvement of combination conduction/convection radiant ovens, portable or permanently affixed in place.

### BACKGROUND OF THE INVENTION

Baking ovens are a very old art as are the more recent ovens using convection and/or conductive cooking surfaces upon which baked goods may be produced with reduced cooking time. Of particular focus within the art is the use a variety of cooking cycles in order to provide greater versatility and improved cooking performance. One common reason for varying cooking cycles was to utilize 110-volt service using elements whose wattage was the UL limit for a 110-volt service. That limit is to have no more than 13.5 steady state amperage draw and a total of 1550 watts. The UL wattage limits for 110-volt ovens, mandated an alternating cycle between upper and lower elements using full 13.5 amp cumulative capacity elements both top and bottom. The desire to provide a 110-volt cooking oven that could be plugged into a common household outlet combined with the need for higher wattage for adequate cooking performance precluded simultaneous upper and lower element operation due to the aforementioned current draw limitations. Until the present invention, alternating energizing of full 110-volt amperage capacity upper and lower cooking elements was necessary to afford adequate cooking performance and preheating times. An early example of this type of alternating cooking cycle oven was the two-stage microwave and radiant cooking technology employed by Raymond L. Dills, U.S. Pat. No. 4,188,520. Dills invention was an attempt to provide browning which microwave cooking alone cannot produce. The first cooking stage was solely microwave cooking and a second stage utilized an electric resistance coil to provide browning This two-stage approach was further improved by Hurko et al., U.S. Pat. No. 4,242,554. Hurko's oven used a multiple alternation between microwave cooking and radiant cooking. This apparently afforded improved browning performance and purportedly created end products that are more consistent with conventional oven performance. The ideal behind the alternating cooking cycles in Hurko's invention was to create an oven whose current draw was reduced to meet UL requirements for common household 110-volt service of no more than a total of 1550 watts and 13.5 steady state amperage draw. The advent of the small, portable convection oven includes Milton H. Farber, U.S. Pat. No. 3,828,760 wherein the cyclonic affect of heated fan driven convective air for rapid cooking was well demonstrated. Farber's convection oven, however, did not anticipate the conductive cooking possibility of utilizing a refractory, conductive cooking surface in conjunction with convection nor the thermal efficiencies as synergistically optimized in the present invention.

More recently, however, within the art, Victor R. Boddy, U.S. Pat. No. 5,695,668, utilized a similar two-stage cooking approach to Dills invention by introducing a portable conduction/convection oven with a conductive cooking slab. Boddy's oven afforded the same ability to produce foods with the rapidity of convective cooking but combined with the Hurko oven's capability to utilize a 110-volt circuit successfully. Boddy's two-stage cooking approach involved a preheating first stage to heat a high thermal mass refractory slab for conductive cooking A conductive cooking second stage, wherein the lower element was de-energized and a convection fan and/or the upper element are activated during the actual cooking cycle was then employed. While Boddy's invention seems to provide a workable 110-volt service convection/conduction oven, there are several disadvantages inherent with that oven.

In order to maintain a stable cooking slab temperature, it is implied in Boddy's invention that a slab with a high thermal mass must be used in order to reduce the rate of heat loss. This is so because of Boddy's two-stage cooking process wherein the lower element that preheats this slab is turned off during the second stage wherein the upper elements are energized for cooking. In Boddy's invention, the embodiment includes a refractory slab that is 1½″ thick and weighing 10 to 15 pounds. Since it is a thermal property that the greater the thermal-mass the slower the rate of heat gain and loss, the inverse is also understood (i.e. that the less the thermal-mass the more rapidly heat gain and loss occurs.) Further, it is common knowledge within the art that the consistency in the quality of baked goods produced by conductive cooking is directly related to the stability and even temperature of the cooking surface. By selectively heating the slab from beneath and then de-activating the element beneath the slab, the temperature of a slab of any thermal mass will inevitably decline. It is common knowledge within the art that stable conductive cooking surface temperatures are desirable so this occurrence in Boddy's slab is not desirable. The rate of slab temperature drop will be only partially offset by the small amount of radiant and convective heat provided from above that has contact with the bare upper slab surface. Most of this upper element source energy is absorbed by the foods being cooked. The rate of slab temperature drop is further influenced by the degree of temperature difference between the slab's temperature setting and the convective oven temperature setting. The rate of slab temperature drop is further accelerated if cold or frozen foods are placed on the slab. This is so since, in either situation whether heating air, slab or food, the rate of enthalpy is proportional to the temperature differences of the media involved. To reiterate, three primary problems exist with using Boddy's high thermal mass slab.

First, by using a high thermal mass conductive cooking slab, the rapid temperature drop desired when cooking puff pastries is not possible. Preparing puff pastry is a two stage cooking process. The first stage involves a high temperature of usually 425 to 450 degrees F. The second stage involves a lower temperature of usually 350 degrees F. Therefore, Boddy's high thermal mass slab with it's slow temperature drop is not feasible for cooking puff pastry. However, the use of a low thermal mass slab, as described in the present invention, is desirable.

Secondly, the use of a high-density slab makes the oven unnecessarily heavy. An improvement afforded in the present invention resolves this as will be elaborated below. The slab material costs and the cost to ship a heavier oven will cause the resulting retail price to be higher and/or profit margins to be smaller in order to compete in this market. Further, the difficulty in carrying and installing under counter or cabinet is also increased unnecessarily.

A third disadvantage of using a high-density slab is that preheat times are excessive making the oven thermally inefficient. Boddy's preferred embodiment indicated that initial preheating takes approximately one hour. While this preheating time is shorter than for some large brick pizza ovens in the prior art for commercial usage, it is unacceptable for a consumer oven.

In the preferred embodiment shown in FIG. 3, the use of infrared light bulb(s) 9A is shown with wire mesh screen(s) 37, used to guard the bulbs from damage by the user. The art has anticipated the use of infrared light bulbs for the purpose of maintaining food warmth in restaurant food pick-up areas and even in the use of “finishing” a greaseless french-fry as with Taylor, U.S. Pat. No. 5,997,938 or Kester, U.S. Pat. No. 6,013,296. However, the use of infrared bulbs for the purpose of cooking raw or unheated foods to a finished state has not been heretofore demonstrated until the present invention.

Scott, U.S. Pat. No. 4,942,046 demonstrates the use of infrared lamps in the aforementioned context of maintaining prepared food above a preselected warming temperature. While this inventions presents an improvement of the prior restaurant food heating heat lamp application by providing optical sensor controls of the heating cycles, it does not anticipate the use of infrared bulbs for cooking of raw or unheated foods, as does the present invention. Scott also does it afford the many aforementioned or other objects of the present invention to be elaborated below.

McCarter, U.S. Pat. No. 6,294,769 discloses a food warming device with the express purpose of maintaining a constant serving temperature without further cooking the food using quartz type, electric resistance elements. This invention thereby does not anticipate the use of infrared bulbs for deep penetrative cooking, offering the many aforementioned objects of the present invention;

The deficiencies of the less relevant prior art are listed below.

Ishammar, U.S. Pat. No. 4,010,341 shows a hot air oven with an air circulating fan, a heater and circulation passages but also does not anticipate conductive cooking slab capabilities nor the thermal efficiencies as synergistically optimized in the present invention.

Vogt, U.S. Pat. No. 4,068,572 shows an apparatus for heating food using a horizontally displayed fan, but also does not anticipate conductive cooking slab capabilities nor the thermal efficiencies as synergistically optimized in the present invention.

Riccio, U.S. Pat. No. 5,605,092 while anticipating an oven with a stone covered bottom and supplemental heater, represents a heavy, high density, brick commercial type oven but does not anticipate the thermal efficiencies as synergistically optimized in the present invention.

Llodra, Jr. et al., U.S. Pat. No. 6,041,769 shows a portable brick oven with an arrangement of bricks and allows for convective/conductive heating. However this oven uses natural gas or propane, which is not as commonly available as the 110-volt electrical service used by the present invention nor does it anticipate the thermal efficiencies as synergistically optimized in the present invention.

McKee, et al., U.S. Pat. No. 6,060,701 shows a compact quick-cooking conventional oven. While this oven utilizes a cyclonic vortex hot airflow convective cooking system, it represents a different air flow path than the present invention, and moreover, does not anticipate conductive cooking slab capabilities nor the thermal efficiencies as synergistically optimized in the present invention.

Beyond the improvements introduced to this field by the aforementioned prior art, as yet, the art has not seen a lightweight, thermally efficient portable, 110-volt capable oven that affords effective cooking performance, using lower cumulative wattage elements and infrared bubls without requiring an alternating cooking cycle with its resulting slab temperature fluctuations. The present invention solves these disadvantages while affording several new and significant improvements in energy efficiency, improved cooking versatility and end product quality. It should be noted that the present invention does not preclude the possibility of a 240-volt oven that incorporates the thermal efficiency improvements as applied to a 110-volt oven. As either oven would benefit from the thermal efficiency improvements of the present invention. The current invention's 110-volt, preferred embodiment can cook all foods conventionally baked in small portable ovens in about 12% to 18% of the packaged oven time indicated, using just a total of 1200 watts. The use of (2) 250 watt infrared light bulbs with their exceptional infrared output efficiency and (2) 350 watt elements below the conductive cooking slab in conjunction with other collective thermal efficiency improvements elaborated below make this possible. Since the cumulative wattage of the present invention is below the 1550 watt UL limit for a 110-volt service, simultaneous operation of the upper and lower elements is now possible without sacrificing cooking performance, exceptional cooking and preheating times and while affording exceptional energy savings.

### SUMMARY OF THE INVENTION

The present invention, in its preferred embodiment, is a portable, thermally efficient, low voltage, conduction/convection/radiant oven that successfully overcomes the foregoing disadvantages of the prior art by means of the following benefits;

(a) a portable or permanently affixed oven wherein its lower heating elements are shielded and are of a lower wattage, allowing a closer element location to the lightweight conductive cooking slab without cracking it due to thermal shock;

(b) a portable or permanently affixed oven wherein its lower element shields' inner lower surfaces are anodized to a gold metallic hue, fabricated of brass, brass plated or otherwise colored to this hue, reflecting infrared radiation from the lower elements in a widely distributed pattern. This finish causes reflection of the infrared radiation energy from being absorbed into the shields, reducing their temperature. This in turn reduces the concentrated radiant heat emission from the top of the shields from entering the lightweight conductive cooking slab, further reducing the possibility of thermal shock cracking;

(c) a portable or permanently affixed oven wherein its lower element shields' inner lower surfaces' wide distribution pattern provides an even infrared radiation distribution to be cast off the lower element chamber's surface and further reflected upwards into the conductive cooking slab's lower surface. This even distribution affords a uniform heating of the conductive cooking slab for optimal cooking performance and reduced thermal shock cracking potential during the preheat cycle;

(d) a portable or permanently affixed oven wherein its closer element location to the lightweight conductive cooking slab allows the lower element compartment to have a reduced depth, reducing the overall oven height by 2″ to 3″ over a chamber operating with a cumulative 1550 watts of lower element capacity. This allows the oven to be lower profile for feasible tight under counter and under cabinet installations;

(e) a thermally efficient, portable or permanently affixed oven wherein its cumulative upper and lower element wattages or upper bulb and lower element wattages total less than the 1550 watts and 13.5 steady state amperage draw UL limits for a 110-volt circuit yet still affords exceptional preheating times, cooking times and performance with all the traditional varieties of foods cooked in portable ovens;

(f) a portable or permanently affixed oven wherein its infrared bulbs' low convective heat output allow the cooking chamber height to be reduced, causing foods to be located closer to these bulbs without scorching the foods;

(g) a portable or permanently affixed oven wherein its reduced cooking chamber height and resulting reduced chamber volume also reduces preheating time and cooking times with resulting energy savings;

(h) a portable or permanently affixed oven wherein its reduced cooking chamber height enables the overall oven height to be further reduced to a low profile oven for easier installation in tight under counter or under cabinet applications.

(i) a portable or permanently affixed oven wherein its minimum slab thickness of ¼″ to maximum ⅝″ is lighter, weighing approx. 4 to 7 pounds, thus reducing the slab's weight 6 to 11 pounds below the slab in the preferred embodiment of Boddy's oven. This lighter weight slab has reduced material costs, reduces overall oven shipping costs and makes the oven easier to carry and install in tight under counter or under cabinet installations.

(j) a portable or permanently affixed oven wherein its low thermal mass conductive cooking slab requires as little as 4 to 7 minutes to preheat dependent the specific slab thickness used and upon actual voltage service to the appliance between the normal 105 volt to 120 volt range, thus using less energy;

(k) a portable or permanently affixed oven wherein its low thermal mass conductive cooking slab temperature is maintained optimally stable by the constant operation of its lower heating element(s) during conductive cooking uses. This stable conductive cooking surface temperature affords superior cooking results as is commonly recognized in the art;

(l) a portable or permanently affixed oven wherein its low thermal mass conductive cooking slab temperature drops quickly when desired for the high to low temperature, two stage cooking cycle inherent when preparing of puff pastry;

(m) a portable or permanently affixed oven wherein its thermal glass front door is sloped backwards from the lower edge, affording greatly improved visibility within the oven, improved convective heat deflection downward toward the food and a reduced cooking chamber volume for reduced preheating times, reduced cooking times and resulting energy savings;

(n) a portable or permanently affixed oven wherein its back wall 7 is also sloped forward from the bottom edge, affording improved convective heat deflection downward toward the food and a reduced cooking chamber volume for reduced preheating time, reduced cooking times and resulting energy savings;

(o) a portable or permanently affixed oven wherein its upper cooking chamber wall is anodized to a gold metallic hue, fabricated of brass, brass plated or otherwise colored to this hue in order to optimize the reflection of infrared heat and further improved thermal efficiency. This optimal infrared heat deflection affords significantly improved deep cooking performance, particularly of raw dough baked goods using the lower wattage, upper elements;

(p) a thermally efficient portable or permanently affixed oven wherein its upper cooking chamber's heating source are (1) or more infrared light bulbs;

(q) a thermally efficient portable or permanently affixed oven whose upper cooking chamber's infrared bulb(s) provide a self contained infrared reflective capability thus eliminating the need to use gold reflective anodize upon the upper surface of the oven's cooking chamber as would be needed for electric resistance elements;

(r) a thermally efficient portable or permanently affixed oven whose upper cooking chamber's infrared bulbs provide a unidirectional focusing of infrared radiation that provides a doubled infrared efficiency and an approximate halving of the cooking time over using conventional electric resistance elements within the cooking chamber;

(s) a thermally efficient portable or permanently affixed oven wherein its upper cooking chamber's “flood light” configured infrared bulb embodiment provides an inherently broader and more even distribution of infrared radiation to the foods than the relatively linear distribution inherent in conventional electric resistant elements;

(t) a thermally efficient portable or permanently affixed oven wherein its upper cooking chamber's infrared bulb('s)(s') low thermal mass heating element reaches peak infrared output faster than conventional higher thermal mass electrical resistance elements resulting in a faster cooking time;

(u) a thermally efficient portable or permanently affixed oven wherein its upper surface 34 of the lower pan 33 is also anodized to a gold metallic hue, fabricated of brass, brass plated or otherwise colored to this hue in order to optimize the reflection of infrared radiation and further improved thermal efficiency. This affords greater infrared reflection for accelerated preheating of the conductive cooking slab 6 and resulting energy savings;

(v) a thermally efficient portable or permanently affixed oven wherein its lower surface 19 of conductive cooking slab 6 is famished black in color, creating a “black body” for optimized slab infrared radiation absorption. This improvement further reduces preheating time and affords additional energy savings;

(w) a portable or permanently affixed oven wherein its control means programmability can provide variable and multiple combinations of heating element temperature modulation and convection fan operation and/or speed to optimize energy efficiency, improve cooking versatility and the quality of food end products cooked within it using traditional ICL circuit programming;

(x) a portable or permanently affixed oven designed to operate at 240-volts that incorporates the aforementioned thermally efficient modifications described above.

### BRIEF DESCRIPTION OF THE DRAWINGS

FIG. 1 is a front elevation view thereof;

FIG. 2 is a section view taken of FIG. 1 thereof;

### DETAILED DESCRIPTION OF PREFERRED EMBODIMENT

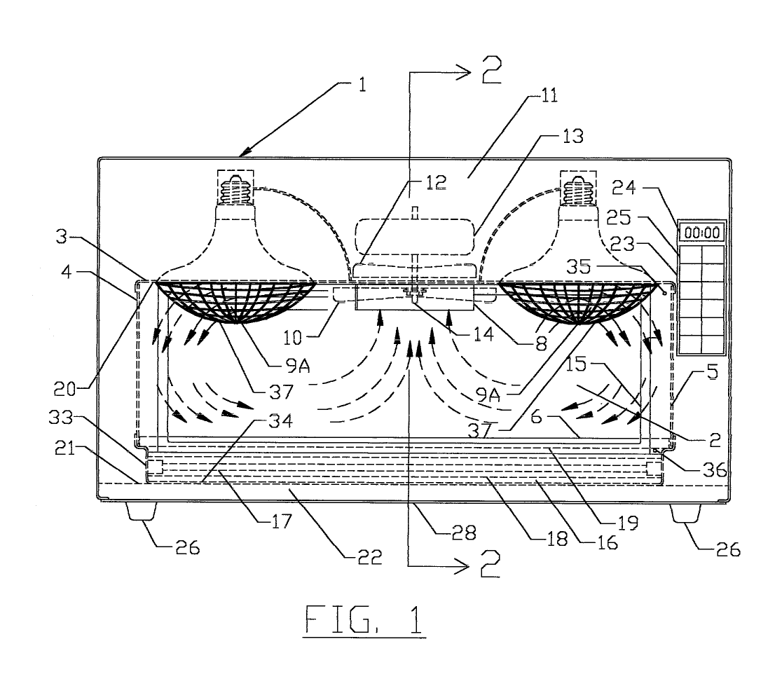

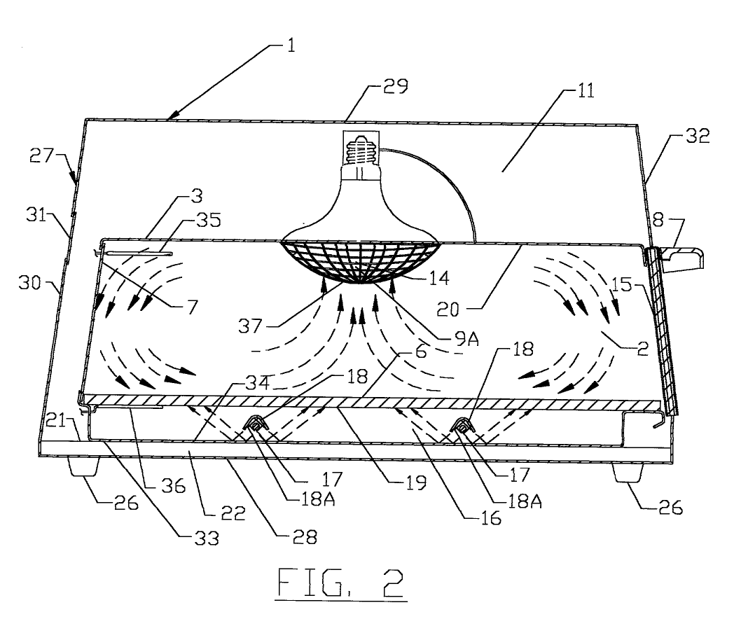

Certain terminology is used herein for convenience only and is not to be taken as a limitation on the present invention. Referring to FIGS. 1 and 2, FIG. 1 shows a front view of the improved thermally efficient portable oven 1. The oven has a cooking chamber 2 comprised of an upper wall 3, sidewalls 4 and 5, conductive cooking slab 6, back wall 7, front panel 32 and door 15. Door 15 has a handle 8 used to open the oven. A thermostat whose temperature probe 35 is located in the cooking chamber 2 controls the chamber's cooking temperature. Lower temperature probe 36 in like manner is connected to a thermostat, is located within lower element chamber 16 and controls the lower chamber's cooking temperature. Conductive cooking slab 6 has a lower surface 19 that may be high temperature paint finished black, creating a “black body” for optimal infrared absorption. The infrared bulb(s) contain an inherent reflective surface that most efficiently directs the radiation downwards, unidirectionally towards the food. The conductive cooking slab 6, is comprised of stone, ceramic, cordierite or other appropriate materials currently in common use for this purpose. Conductive cooking slab 6 is also removable, able to be slid forward out from the opening of door 15 for cleaning or replacement The thickness of conductive cooking slab 6 in the preferred embodiment for either a 110-volt or 240-volt oven is ⅜″ thick affording the best balance between shortened preheat time, quick temperature ramp-down time when cooking puff pastry, resistance to thermal shocking and adequate overall durability. In the preferred embodiment conductive cooking slab 6 measures 14″×14″, sized to accommodate a medium 13″ pizza. However, an enlarged oven chamber design could be made with a conductive cooking slab 6 measuring 17″×17″, large enough to accommodate a large 16″ pizza. Cumulative wattages of the infrared bulb(s) 9A, and the two lower elements 17 allow for their simultaneous and continuous operation using a 110-volt circuit. In the preferred embodiment for a 110-volt oven, there are two lower elements @ 350 watts and two infrared bulbs @ 250 watts for a cumulative 1200 watts. However, lower element wattages as low as 2 @ 225 watts up to the 110-volt limit of approximately (2) @ 390 watts can be used successfully. Infrared bulbs are effective for deep food heating with as little as one 175 watt bulb to (2) bulbs @ the highest currently available wattages of 375 watts. The minimum cumulative wattage affording acceptable deep food heating performance can be, therefore, as little as 625 watts. It was noted that due to the infrared bulbs relatively small convective heating output there was excellent and only improved cooking time results with an increase of bulb wattage. An oven tested with the improvements disclosed of the present invention, using (2) 250-watt bulbs and (2) 350 watt lower elements, cooked a frozen deep-dish pizza, whose normal conventional oven cooking time is 24 to 28 minutes, in just 4 minutes. With a 240-volt service oven, the capacities listed above would be doubled. That being the cumulative wattage of upper and lower elements would be 2150 watts with (2) 700 watt lower elements and (2) 375-watt bulbs. Lower element wattages as low as (2) @ 450 watts up to approximately (2) @ 780 watts can be used successfully. The lower elements may be cal-rod or quartz or aluminum. The door 15 and front panel 32 are sloped backward from the bottom vertical plane of the oven 4.5 degrees in the preferred embodiment, however, sloping as much as 45 degrees may be made without creating significant detriment to the door's and panel's downward air deflection performance. A slope in excess of 45-degrees places the door in a more horizontal than vertical orientation. This orientation reduces visibility, increases upward flowing heat losses through the glass and creates less than optimal downward convective air deflection. The back wall 7 is also sloped forward from the bottom vertical plane of the oven 4.5 degrees with a similar 45-degree maximum slope recommendation in order to prevent detriment to the downward deflection of convective air. A convection fan 10 is located approximately centered in the upper wall 3 of the oven for even air distribution. The advantage of using multiple bulbs 9A is that they can cast infrared radiation more evenly over the surface of larger foods such as pizza's. The criticality of the distance of the infrared bulbs from the food is far less important that that of electric resistance elements and is more a function of necessary clearance for higher profile foods. This is due to the extraordinary infrared output of the bulbs that means that effective cooking and heating can be obtained with the bulbs with even as much as 6 inches clearance when using the highest wattage 375 watt bulbs. Since the intensity of infrared radiation reduces by the square of the distance, in the preferred embodiment, there is an optimal cooking chamber 2 height. Measured from the upper surface of conductive cooking slab 6 to the lower surface of infrared bulb(s) 9A this height is 4″ for a 110-volt oven, and is thus large enough to accommodate taller foods. However, dependent upon the actual wattage of bulbs chosen within the disclosed wattage range above, this distance could be as low as 2.5″ to as high as 6″ corresponding to the lowest and highest wattage ranges respectively for a 110-volt oven. The infrared cooking performance is critical to this oven, particularly for the lower wattage, 110-volt oven, in that it affords the deep cooking affect, similar to microwave cooking. These infrared enhancements partially compensate for the lower wattage of the present invention's 110-volt, infrared bulb(s) & lower elements 17, affording disproportionately shortened cooking times and deep cooking ability for the actual wattages required. The deep cooking affect of infrared radiation is of particular benefit for successful preparation of raw dough baked goods using the present invention's lower wattage, 110-volt infrared bulb(s). An upper chamber 11 is formed between the outer assembly 27 and the aforementioned parts of the cooking chamber, sized adequately to accommodate the bulbs 9A, motor 10 and cooling fan 12. Within upper chamber 11 is located convection fan motor 13 cooling fan 12 and shaft 14 which drives both cooling fan 12 and convection fan 10. Upper chamber 11 also contains electrical wiring not shown. In the preferred embodiment for either 110-volts or 240-volts, fan motor 13 is a constant speed, 1000 rpm, high temperature motor, however, a variable speed, high temperature motor may also be used for additional crisping control. The front panel 32 contains a touch controller 23 containing keypads 25 and timer/clock 24. Touch controller 23 is shown as an electronic controller in the preferred embodiment, designed to be used with an ICL program. However, independent timers, fan switches and temperature indicator lights could also be used. Below conductive cooking slab 6 is lower element chamber 16. Lower pan 33 contains lower elements 17, lower element chamber 16, element shields 18 and lower slab temperature probe 35. Temperature probe 35 is located adjacent to conductive cooking slab 6 and is used to control its temperature. By using low wattage, lower elements 17 and element shields 18, the depth of lower element chamber 16 may be reduced by 2″ to 3″ over that required when using full 110 volt capacity, 1550 cumulative wattage lower elements. Lower element chamber 16 may be reduced by 1″ to 3″ over that required using full 240-volt capacity, 3100 cumulative wattage elements. The use of low wattage, lower elements 17 with lower element shields 18 prevent thermal shock cracking of the low thermal mass conductive cooking slab 6. The lower edges of shields 18 should not be located appreciably lower than the centerline of lower elements 17, as the intent is to redirect the upward directed infrared radiation downward away from conductive cooking slab 6. The lower halves of elements 17 provide lateral and downwardly directed infrared radiation and do not require the deflection required by the upper halves of lower elements 17. The depth of element chamber 16 in the preferred embodiment is 1″ deep for a 110-volt oven and 3″ deep for a 240-volt oven. However a depth as little as ¾″ to as much as 2″ can be utilized for a 110-volt oven with varying preheating time results and should be adjusted to accommodate the possible wattage ranges disclosed above. Similarly, lower element chamber 16 height for a 240-volt oven must be increased as the wattages for lower elements 17 increase for that oven in order to mitigate thermal shock cracking of the low thermal mass conductive cooking slab 6. In order to optimize the oven's overall height to a low profile, it is desirable to keep this lower element chamber 16 height to a minimum. It should be noted that from a low profile installation consideration, the 110-volt oven option is a preferable choice for design. However, from a faster preheating and cooking rate perspective, the 240-volt oven is a preferable design choice. In either instance, significant energy consumption savings from reduced preheating and cooking times can be realized with the thermal efficiencies of the present invention. The optimal height of lower element 17 within lower element chamber 16 should be as follows for either a 110-volt or 240-volt oven. The centerline of lower elements 17 should not be located appreciably lower than at mid height of lower element chamber 16. Lower elements 17 could be located as high as within ¼″ from the lower surface 19 of the conductive cooking slab 6 as measured from the top of shields 18 for a 110-volt oven. This distance, however, should be located no closer than ¾″ for the same clearance on a 240-volt oven. The higher that lower elements 17 are located above the upper surface 34 of lower pan 33, the broader the distribution of reflected infrared radiation onto upper surface 34 and upwards to lower surface 19 of conductive cooking slab 6. This infrared reflection from shields 18 and subsequent reflective distribution to lower surface 19 of conductive cooking slab 6 is illustrated with infrared directional flow arrows in FIG. 2. To locate shields 18 closer to the lower surface 19 of conductive cooking slab 6 is to increase the heat conduction potential from shields 18 into conductive cooking slab 6. This also increases the thermal shock cracking potential. This potential is greatest early in the preheating cycle when the slab is cold. This propensity for cracking is even greater when using the higher wattage elements on a 240-volt oven. This shallow lower element chamber 16 allows oven 1 to be of lower profile, fitting more readily in tight under counter or under cabinetry installations especially for the 110-volt oven. The shallow depth of lower element chamber 16 further enhances the thermal efficiency of the oven in that the temperature rises faster in this chamber and consequently of conductive cooking slab 6. This 1″ shallow depth of element chamber 16 for the 110-volt oven reduces the preheat time by over one minute. FIG. 2 shows a section of the oven as shown in FIG. 1 and illustrates the uniquely sloped front panel 32 that contains door 15 and also houses touch controller 23 with timer/clock 24 and keypads 25. Also indicated in FIG. 2 is the rear panel 30 that houses vent screen 31. Vent screen 31 provides for the free inlet and outlet of ambient air used to cool upper chamber 11. The inverted “V” shaped element shields 18 can be better seen in FIG. 2. The inner surface 18A of element shields 18 are also gold hue anodized or otherwise tinted to optimize their downward reflection of infrared radiation from lower elements 17. This gold hue tinting reflects infrared radiant heat away from shields 18 rather than allowing it to be absorbed into them. This prevents the shields 18 from becoming excessively hot during the early and most critical stages of the preheating cycle when thermal shock cracking of the conductive cooking slab 6 is most likely to occur as stated previously. Cracking is prevented because the reflection of infrared radiation from shields 18 rather than its absorption reduces their temperature early on in the preheating cycle. This further reduces the linear heat concentration radiated from the top of shields 18 from being conducted into the conductive cooking slab 6. This reduced temperature difference between the shields 18 and slab 6 reduces the resulting thermal shock cracking potential. Upper surface 34 may be similarly gold hue anodized or otherwise tinted for an increased and optimally even reflection of infrared radiation from lower elements 17 and shields 18 upwards against the lower surface 19 of conductive cooking slab 6. By increasing the distance the infrared radiation must travel before reaching conductive cooking slab 6, the resulting magnitude is decreased that contacts the slab. This diminished, indirect and even reflection of this infrared radiation prevents the otherwise concentrated radiation from lower elements 17 from cracking the low thermal mass conductive cooking slab 6. These features are particularly important when incorporating the shallow depth in lower element chamber 16 and when applied to a 240-volt oven where the infrared intensities are much greater. As an alternative approach to using lower wattage, lower elements 17, conductive cooking slab 6 thickness could be increased to ½″ to ⅝″ and/or the distance from lower elements 17 to lower surface 19 could be increased. However cracking potential is mitigated, the former option is preferable in that neither additional weight nor height is added to the oven and because a low-profiled, lightweight oven with optimal thermal efficiency is an object of the present invention for either 110-volt or 240-volt ovens. It should be reiterated, however, that the 110-volt option lends itself best to the objective of creating a low-profile oven. This is evident, as the clearance information disclosed above substantiates, that the magnitude of clearances and consequent overall height increase of oven 1 must be made for a successful application of these improvements for a 240-volt oven. FIG. 2 most clearly illustrates outer assembly 27. This assembly, comprising of parts listed from top to bottom, and includes, cover panel 29, rear panel 30 that includes vent screen 31, front panel 32, lower panel 28 and base supports 26 located near each corner of lower panel 28. Between lower pan 33 and the lower panel 28 is insulation pan 21 that contains one or more layers of a high-density insulation 22 to contain the heat for safety and greater energy efficiency. It is to be understood that the form of the invention herein shown and described is to be taken as a preferred example of the same. Various changes in the shape, size, materials and arrangements of parts may be resorted to without departing from the spirit of the invention or the scope of the appended claims. Many other variations are possible. One variation may show the lower surface 19 being the natural color of the slab material rather than colored to a “black body” finish. The lower surface 20 of upper wall 3 may be of natural metallic color rather than gold hue colored without serious detriment to the overall oven performance, particularly because infrared bulb(s) 9A, with their inherent unidirectional focused reflective capability are used. All interior chamber 2 surfaces (i.e.—side walls 4 & 5 and back wall 7) could also be gold hue anodized, composed of brass, brass plated or otherwise colored to a gold metallic hue. Door 15 and back wall 7 could be in a vertical orientation, with the addition of separate air deflection panels to direct convective air downwards toward the food. Side walls 4 & 5 could also be sloped downwards from the vertical plane to reflect infrared radiation and convective air downward to the food. Modified infrared lamps that are flush with the oven surface and are of a low profile could also be utilized to further reduce the height of the oven and simplify bulb replacement. A vertically oriented door 15 and front panel 32 could be made taller with more glass surface area to enhance visibility within the oven. A variable speed fan motor could be used in lieu of a constant speed fan. Lower element shields 18 could be semi-circular rather than “V” shaped and could be fabricated of a low conducting, highly reflective material in lieu of metal. The proportional wattage distribution between infrared bulb(s) 9A with lower elements 17 could also be made.

1. A 110-volt service oven comprising;
a) an oven chamber for receiving and cooking foods,
b) one or more upper heating infrared light bulbs located in said oven chamber,
c) a screen or other guard to protect said bulb(s) from damage by the user,
d) a convection fan located in said oven chamber,
e) a low thermal mass conductive cooking slab located at the bottom of said oven chamber, supporting foods received,
f) one or more lower heating elements located below said cooking slab providing constant heating of said cooking slab during conductive cooking uses,
g) the cumulative simultaneously energized wattage of said upper bulb(s) and said lower element(s) does not exceed UL limits for 110 volt service, which as of this date is limited to a total of 1550 watts and 13.5 steady state amperage draw,
h) a power supply for delivering power to said upper bulb(s), said lower element(s) or both as required for the unique cooking requirements of diverse foods prepared,
i) a cooking chamber temperature probe and a conductive cooking slab temperature probe that are connected to a thermostat for independent monitoring and control of said oven chamber and said conductive cooking slab temperatures.

2. The oven of claim 11 wherein said refractory slab is a wire rack, or otherwise porous rack with adjustable height capability.

3. The oven of claim 1 wherein a lower pan is located below said lower heating elements, said lower pan having an upper surface that is gold anodized, brass, brass plated or otherwise colored to a gold metallic hue for optimal infrared reflection.

4. The oven of claim 1 wherein said cooking chamber has a back wall that is sloped forward from the lower edge in relation to the vertical plane for improved downward convective air deflection.

5. The oven of claim 1 wherein said cooking chamber has a front wall containing a door that are both sloped backward from the lower edge in relation to the vertical plane for improved downward convective air deflection and improved visibility within the oven.

6. The oven of claim 1 wherein said lower heating element(s) have element shield(s) located between said lower heating element(s) and said conductive cooking slab to mitigate thermal shock and afford even reflected distribution of infrared radiation,

7. The oven of claim 1 wherein said element shield(s) have a lower surface facing said lower heating element(s) that are gold anodized, brass, brass plated or otherwise colored to a gold metallic hue for optimal infrared reflection.

8. The oven of claim 1 wherein said convection fan has a variable speed motor.

9. The oven of claim 1 wherein said conductive cooking slab has a lower surface that is high temperature finished to a black color, creating a “black body” for optimal infrared absorption.

10. The oven of claim 1 wherein said conductive cooking slab is removable through an opening of said door for cleaning or replacement.

11. A 240-volt circuit oven comprising;
a) an oven chamber for receiving and cooking foods,
b) one or more infrared light bulbs located in said oven chamber,
c) a screen or other guard to protect said bulb(s) from damage by the user,
d) a convection fan located in said oven chamber,
e) a low thermal mass conductive cooking slab located at the bottom of said oven chamber, supporting foods received,
f) one or more lower heating elements located below said cooking slab providing constant heating of said cooking slab during conductive cooking uses,
g) a power supply for delivering power to said infrared bulb(s), said lower element(s) or both as required for the unique cooking requirements of diverse foods prepared,
h) a cooking chamber temperature probe and a conductive cooking slab temperature probe that are connected to a thermostat for independent monitoring and control of said oven chamber and said conductive cooking slab temperatures.

12. The oven of claim 11 wherein said refractory slab is a wire rack, or otherwise porous rack with adjustable height capability.

13. The oven of claim 11 wherein a lower pan is located below said lower heating elements, said lower pan having an upper surface that is gold anodized, brass, brass plated or otherwise colored to a gold metallic hue for optimal infrared reflection.

14. The oven of claim 11 wherein said cooking chamber has a back wall that is sloped forward from the lower edge in relation to the vertical plane for improved downward convective air deflection.

15. The oven of claim 11 wherein said cooking chamber has a front wall containing a door, and side walls that are both sloped backward from the lower edge in relation to the vertical plane for improved downward convective air deflection, a reduced cooking chamber volume for improved preheating times and improved visibility within the oven.

16. The oven of claim 11 wherein said lower heating element(s) have element shield(s) located between said lower heating element(s) and said conductive cooking slab to mitigate thermal shock and afford even reflected distribution of infrared radiation.

17. The oven of claim 11 wherein said element shield(s) have a lower surface facing said lower heating element(s) that are gold anodized, brass, brass plated or otherwise colored to a gold metallic hue for optimal infrared reflection.

18. The oven of claim 11 wherein said convection fan has a variable speed motor.

19. The oven of claim 11 wherein said conductive cooking slab has a lower surface that is high temperature finished to a black color, creating a “black body” for optimal infrared absorption.

20. The oven of claim 11 wherein said conductive cooking slab is removable through an opening of said door for cleaning or replacement.
